(19) United States
(12) Patent Application Publication
(10) Pub. No.: US 2017/0232815 A1
(43) Pub. Date: Aug. 17, 2017

(54) VEHICLE HVAC OUTLET AND GRILLE ELEMENTS

(71) Applicants: Kenneth S Deneau, Clarkston, MI (US); Adam T Woodward, Detroit, MI (US); Calin Marginean, Lake Orion, MI (US)

(72) Inventors: Kenneth S Deneau, Clarkston, MI (US); Adam T Woodward, Detroit, MI (US); Calin Marginean, Lake Orion, MI (US)

(21) Appl. No.: 15/041,336

(22) Filed: Feb. 11, 2016

(51) Int. Cl. B60H 1/00; B60H 1/34

(52) U.S. Cl. CPC B60H 1/00064; B60H 1/3428; B60H 1/00564

(57) ABSTRACT

An air outlet of a heating, ventilation, and air conditioning (“HVAC”) system of a vehicle includes a duct and a plurality of primary vanes. The duct has an inlet aperture for receiving an airflow from the HVAC system, and an outlet aperture that is open to a passenger compartment of the vehicle. The plurality of primary vanes are coupled to the duct at the outlet aperture. Each primary vane has an asymmetrical airfoil shape including a leading edge and a trailing edge. The leading edge is disposed within the duct and upstream of the trailing edge.

### FIELD

The present disclosure relates to a vehicle heating ventilation and air conditioning (“HVAC”) system outlet and grille elements of the outlet.

### BACKGROUND

This section provides background information related to the present disclosure and is not necessarily prior art.

Vehicles typically have a heating ventilation and air conditioning (HVAC) system that includes outlets, also referred to as vents, that direct airflow of conditioned air into a passenger compartment of the vehicle. The vents typically include a plurality of vanes that are configured to direct the airflow to a specific region of the passenger compartment. Typically, the HVAC outlets are located on a dash panel of the vehicle. Typically, the vanes are straight or symmetrically shaped. In some applications, the vanes are movable to permit a user to modify the airflow path and selectively direct the air in specific directions throughout a range of angles relative to the dash panel. At both extremes of this range, typical vanes create turbulence in the airflow and also increase pressure drop across the outlet. In some applications, the range of angles relative to the dash panel is limited due to the orientation of the outlet and the angle of the dash panel.

### SUMMARY

This section provides a general summary of the disclosure, and is not a comprehensive disclosure of its full scope or all of its features.

In accordance with an aspect of the present disclosure, an air outlet of a heating, ventilation, and air conditioning (“HVAC”) system of a vehicle includes a duct and a plurality of primary vanes. The duct has an inlet aperture for receiving an airflow from the HVAC system, and an outlet aperture that is open to a passenger compartment of the vehicle. The plurality of primary vanes are coupled to the duct at the outlet aperture. Each primary vane has an asymmetrical airfoil shape including a leading edge and a trailing edge. The leading edge is disposed within the duct and upstream of the trailing edge.

In accordance with an aspect of the present disclosure, the outlet aperture is formed at an angle relative to a horizontal axis. When a cord line of one of the primary vanes is parallel to the horizontal axis, the one of the primary vanes is configured to direct the airflow at a downward angle relative to the horizontal axis.

In accordance with an aspect of the present disclosure, the primary vanes have a thickness that narrows toward the trailing edge.

In accordance with an aspect of the present disclosure, a low high pressure side of the airfoil shape is convex and a high pressure side of the airfoil shape is convex, the high pressure side being less convex than the low pressure side.

In accordance with an aspect of the present disclosure, a suction side of the airfoil shape is convex and a high pressure side of the airfoil shape is flat or concave.

In accordance with an aspect of the present disclosure, the air outlet is devoid of other vanes downstream of the primary vanes.

In accordance with an aspect of the present disclosure, each of the primary vanes is rotatably coupled to the duct to rotate about a respective longitudinal axis of the primary vane.

In accordance with an aspect of the present disclosure, the primary vanes are coupled together such that rotation of one of the primary vanes causes all of the primary vanes to rotate.

In accordance with an aspect of the present disclosure, the air outlet further comprises a plurality of secondary vanes. The secondary vanes are rotatably coupled to the duct to rotate along a corresponding longitudinal axis of each secondary vane, the secondary vanes being disposed transverse to and upstream of the primary vanes.

In accordance with an aspect of the present disclosure, the longitudinal axis of each of the primary vanes is horizontal and the longitudinal axis of each of the secondary vanes is vertical.

In accordance with an aspect of the present disclosure, the secondary vanes are coupled together such that rotation of one of the secondary vanes causes all of the secondary vanes to rotate.

In accordance with an aspect of the present disclosure, the air outlet further comprises an input member coupled to the one of the primary vanes to slide along the longitudinal axis of the one of the primary vanes. The input member is coupled to the one of the primary vanes for common rotation. The input member is coupled to the one of the secondary vanes and configured to rotate the one of the secondary vanes when the input member slides relative to the one of the primary vanes.

In accordance with an aspect of the present disclosure, each of the primary vanes is fixedly coupled to the duct.

In accordance with an aspect of the present disclosure, each of the primary vanes is configured to direct the airflow in a direction that is transverse to a cord line of each primary vane.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a portion of a dash panel, illustrating a pair of HVAC outlets in accordance with the present teachings;

FIG. 2 is front view of the portion of the dash panel of FIG. 1;

FIG. 3 is a perspective view of a portion of one of the HVAC outlets of FIG. 1;

FIG. 4 is a sectional view of a portion of one of the HVAC outlets of FIG. 1, taken along line 4-4 shown on FIG. 2, illustrating a plurality of vanes in a straight orientation;

FIG. 5 is a sectional view similar to FIG. 4, illustrating the vanes in an upward orientation;

FIG. 6 is a sectional view similar to FIG. 4, illustrating the vanes in a downward orientation; and

FIG. 7 is a sectional view similar to FIG. 4, illustrating a plurality of vanes of a second construction.

Corresponding reference numerals indicate corresponding parts throughout the several views of the drawings.

### DETAILED DESCRIPTION

The following description of the preferred embodiment(s) is merely exemplary in nature and is in no way intended to limit the invention, its application, or uses.

The present teachings are directed toward an air outlet of a vehicle's heating, ventilation, and air conditioning (“HVAC”) system. The air outlet includes a duct and a plurality of vanes that direct airflow from the duct into a passenger compartment of the vehicle. The vanes have an airfoil shape such that the airflow leaves a trailing edge of the vanes to exit the duct and enters the passenger compartment.

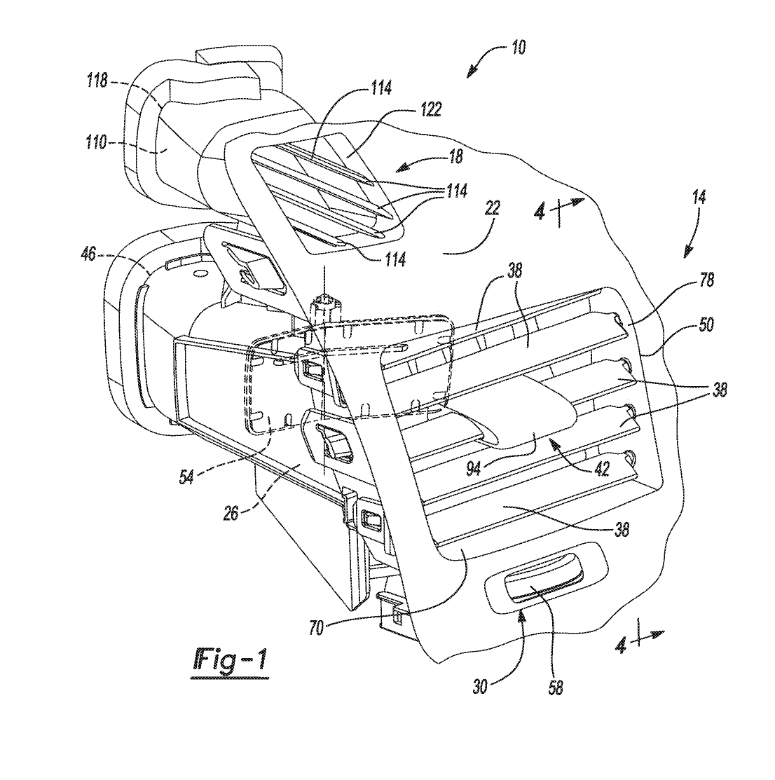

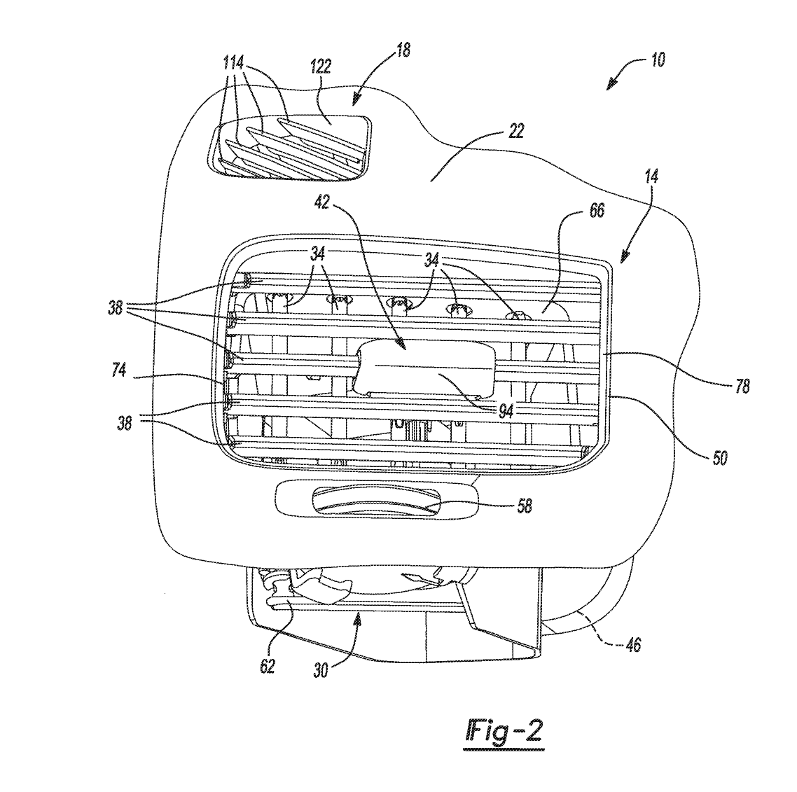

With reference to FIGS. 1 and 2, a portion of an HVAC system 10 for a vehicle (not shown) includes a main air outlet 14 and an auxiliary air outlet 18 attached to a panel 22 of the vehicle (not shown). The panel 22 is any suitable surface of an interior of the vehicle (not shown). In the example provided, the panel 22 is an instrument panel or dash panel. In an alternative construction, not specifically shown, the panel 22 is a trim panel, a vehicle pillar panel, a ceiling panel, a center console panel, or any other suitable surface from which an HVAC system expels air through an air outlet.

The main air outlet 14 includes a duct 26, a baffle mechanism 30, a plurality of secondary direction vanes 34, a plurality of primary direction vanes 38, and a direction mechanism 42. The duct 26 has an inlet aperture 46 and an outlet aperture 50. The inlet aperture 46 is configured to be connected to other ducts (not shown) to receive air blown from a fan (not shown) of the HVAC system 10. The outlet aperture 50 is open at the panel 22 to permit air to flow from the inlet aperture 46, through the duct 26, out the outlet aperture 50 and into a passenger compartment (not shown) of the vehicle (not shown).

The baffle mechanism 30 includes a baffle door 54 and an input wheel 58. The baffle door 54 is disposed within the duct 26 between the inlet aperture 46 and the outlet aperture 50. The baffle door 54 is configured to pivot within the duct 26 to selectively block or permit air to flow through the duct 26. The baffle door 54 is configured to be rotated between a plurality of positions within the duct 26 so as to throttle the amount of air permitted to flow through the duct 26. The input wheel 58 is rotatably mounted in the panel 22 such that a user (not shown) is able rotate the input wheel 58 from within the passenger compartment (not shown). The input wheel 58 is operatively connected to the baffle door 54 by arm members 62, such that rotation of the input wheel 58 rotates the baffle door 54 within the duct 26 to throttle airflow through the duct 26.

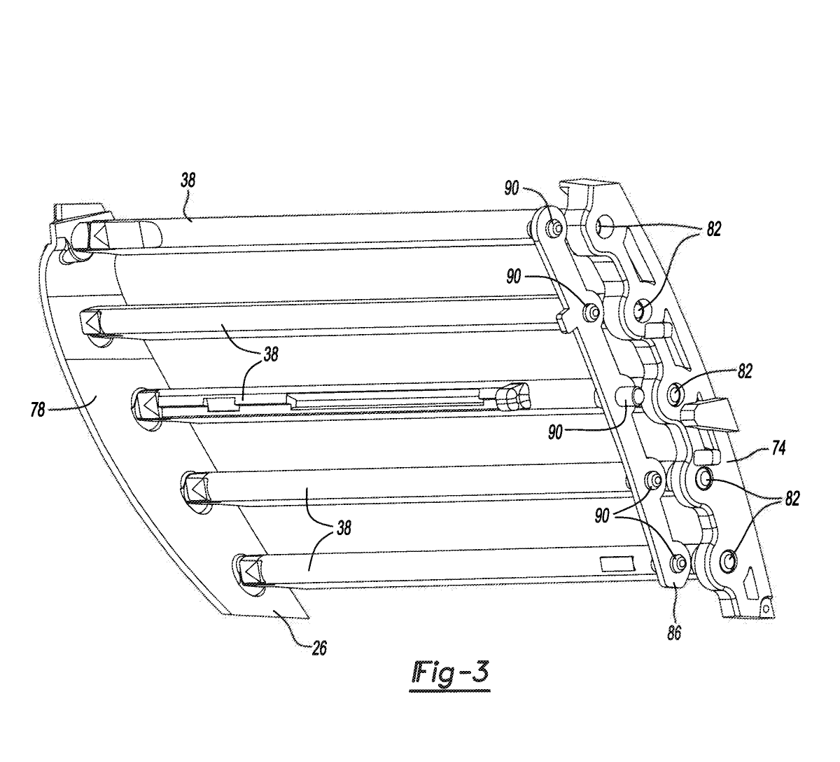

The secondary direction vanes 34 are disposed within the duct 26 proximate to the outlet aperture 50. The secondary direction vanes 34 are downstream of the baffle door 54 and upstream of the primary direction vanes 38. The secondary direction vanes 34 extend longitudinally generally vertically and parallel to each other from a top 66 to a bottom 70 of an interior of the duct 26. In the example provided, the secondary direction vanes 34 are symmetrically shaped. The secondary direction vanes 34 are rotatably coupled to the duct 26 and are connected together to such that rotation of one of the secondary direction vanes 34 along its longitudinal axis causes the other secondary direction vanes 34 to also rotate along their respective longitudinal axes. The secondary direction vanes 34 are coupled together in a manner similar to the primary direction vanes 38 described below and shown in FIG. 3. Rotation of the secondary direction vanes 34 controls the horizontal (e.g., left/right) direction of the airflow exiting the outlet aperture 50. In an alternative construction, not specifically shown, the secondary direction vanes 34 have a different orientation within the duct 26 such that rotation about their longitudinal axes controls the airflow in a direction other than the horizontal direction.

The primary direction vanes 38 are disposed within the duct 26 proximate to the outlet aperture 50. The primary direction vanes 38 are downstream of the secondary direction vanes 34. In the example provided, there are no vanes or other obstructions to airflow downstream of the primary direction vanes 38. The primary direction vanes 38 extend longitudinally generally horizontally and parallel to each other from a left 74 to a right 78 of the interior of the duct 26.

In the example provided, as best shown in FIG. 3, each primary direction vane 38 is rotatably coupled to the duct 26 at a pivot 82 and are connected together by a connecting member 86. The connecting member 86 is rotatably connected to each primary direction vane 38 at a location 90 on that primary direction vane 38 that is upstream of the pivot 82. Rotation of one of the primary direction vanes 38 causes the other primary direction vanes 38 to also rotate along their respective longitudinal axes. Rotation of the primary direction vanes 38 controls the vertical (e.g., up/down) direction of the airflow exiting the outlet aperture 50. In an alternative construction, not specifically shown, the primary direction vanes 38 have a different orientation within the duct 26 such that rotation about their longitudinal axes controls the airflow in a direction other than the vertical direction. In one such example, the primary direction vanes 38 are oriented such that their longitudinal axes are vertical or at an angle that is neither vertical nor horizontal.

Returning to FIGS. 1 and 2, the direction mechanism 42 is configured to selectively rotate the secondary direction vanes 34 and the primary direction vanes 38 independent of the secondary direction vanes 34. In the example provided, the direction mechanism 42 includes an input handle 94 that is mounted to one of the primary direction vanes 38. The input handle 94 is attached to the primary direction vane 38 such that the input handle 94 slides longitudinally (e.g., left and right) along the primary direction vane 38 to which it is mounted. The input handle 94 is coupled to one of the secondary direction vanes 34 such that movement of the input handle 94 longitudinally along the primary direction vane 38 to which it is mounted, causes the secondary direction vanes 34 to rotate. The input handle 94 is attached to the primary direction vane 38 such that rotation of the input handle 94 causes the primary direction vanes 38 to rotate. Thus, up and down movement of the input handle 94 controls up and down directionality of the airflow out of the duct 26, while left and right movement of the input handle 94 controls left and right directionality of the airflow out of the duct 26.

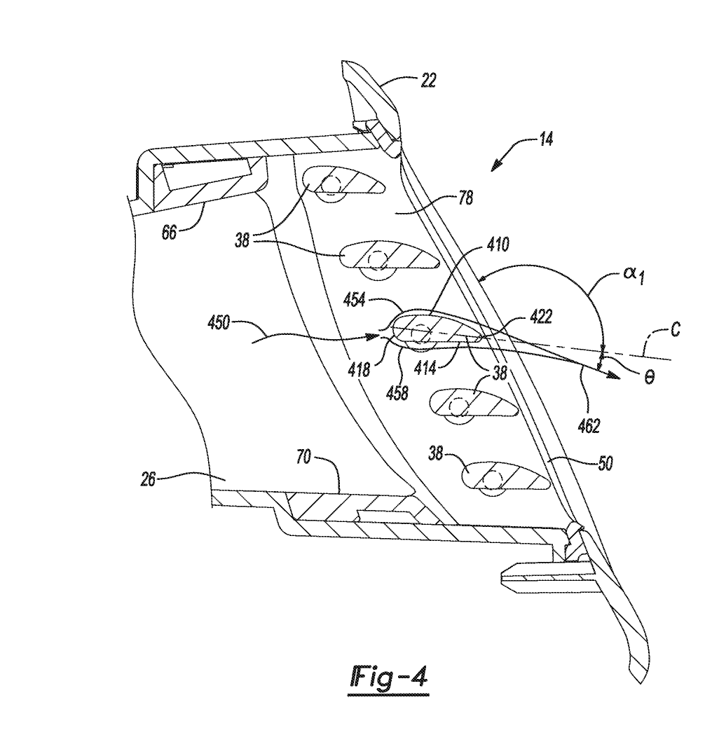

With additional reference to FIG. 4, the primary direction vanes 38 have a subsonic, asymmetrical airfoil cross-sectional shape. The primary direction vanes 38 have a low pressure side 410 and a high pressure side 414 that join upstream to form a leading edge 418 of the airfoil shape and join downstream to form a trailing edge 422 of the airfoil shape. The leading edge 418 and the trailing edge 422 are rounded, but the primary direction vanes 38 are generally thicker toward the leading edge 418 and narrow toward the trailing edge 422. In other words, the airfoil of the example provided is a cambered airfoil, having greater thickness between the chord of the airfoil shape and the low pressure side 410 than between the chord and the high pressure side 414.

In the example provided, the entire low pressure side 410 is convex and the high pressure side 414 is generally flat. In the example provided, the distance between the low pressure side 410 and the high pressure side 414, perpendicular to the chord of the airfoil shape (i.e., the thickness of the airfoil shape), is greatest at a point of greatest thickness between the leading edge 418 and the trailing edge 422. The lateral distance between the leading edge 418 and the point of greatest thickness is less than the lateral distance between the trailing edge 422 and the point of greatest thickness. The thickness of the airfoil shape continually decreases in either direction with increased distance from this point of greatest thickness until reaching leading edge 418 or the trailing edge 422. In the example provided, the low pressure side 410 has a continuously or nearly continuously varying radius between the leading edge 418 and the trailing edge 422, to eliminate visual break or edge lines associated with typical vanes (not shown).

A line parallel with a chord line of the airfoil shape is indicated by reference numeral C. The chord line (i.e., line C) is at an angle α₁ relative to the panel 22. In the example provided the angle α₁ is an obtuse angle. The leading edge 418 is disposed within the duct 26 and the trailing edge 422 is disposed generally at the outlet aperture 50 such that the trailing edge 422 is visible from the passenger compartment (not shown).

In an alternative construction, not specifically shown, the high pressure side 414 is convex to a lesser degree than the low pressure side 410.

In the example provided, airflow from the inlet aperture 46 (FIG. 1) of the duct 26 to one of the primary direction vanes 38 is indicated schematically by arrow 450. It is understood that airflow through the duct 26 passes similarly over all of the primary direction vanes 38. The leading edge 418 of the primary direction vane 38 causes the airflow 450 to split in order to travel around the primary direction vane 38. A portion 454 of the airflow 450 travels along the low pressure side 410 of the primary direction vane 38 and a portion 458 of the airflow 450 travels along the high pressure side 414 of the primary direction vane 38. The portion 454 traveling along the low pressure side 410 has a higher velocity and lower pressure than the portion 458 traveling along the high pressure side 414.

As the portions 454, 458 leave the primary direction vane 38 from the trailing edge 422, the portions 454, 458 generally converge to form an exit airflow 462 that exits the duct 26 at the outlet aperture 50. The exit airflow 462 generally exits the duct 26 at an angle θ relative to the chord line (i.e., line C). In the example shown in FIG. 4, when the chord line (i.e., line C) is a horizontal axis (i.e., level to the ground), the angle θ is such that the exit airflow 462 exits the duct 26 at a downward angle. The asymmetrical airfoil shape of the primary direction vanes 38 causes the angle θ to be greater than with typical, straight vanes (not shown), which are typically symmetrical about a center line, or curved vanes (not shown), which typically have a constant thickness along their cross-sections. In the example provided, there are no other vanes downstream of the primary direction vanes 38, such that the air immediately exits the duct 26 after the primary direction vanes 38.

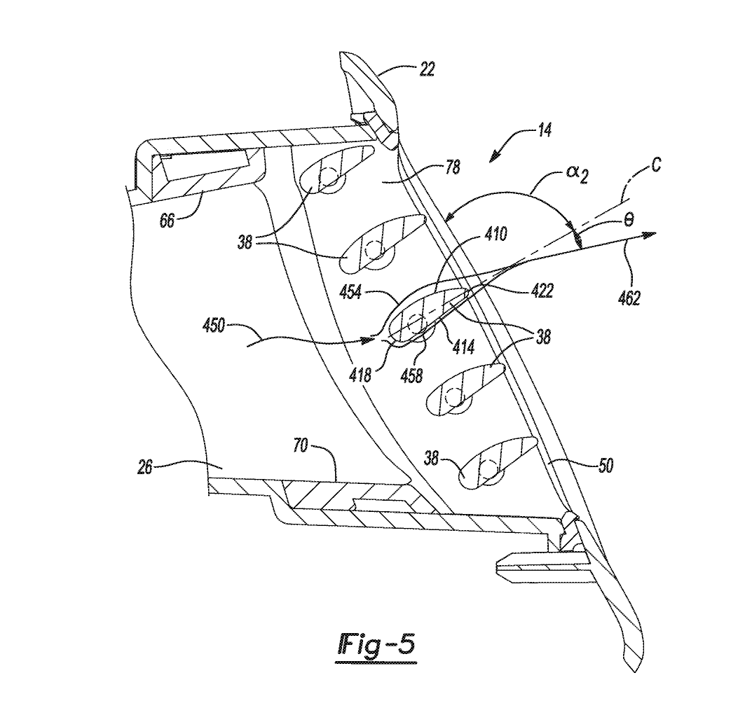

With additional reference to FIG. 5, the primary direction vanes 38 are rotated counter clockwise about their longitudinal axes such that the chord line (i.e., line C) is at an angle α₂ relative to the panel 22. In the example provided, the angle α₂ is less than α₁ (FIG. 4) and is such that the primary direction vanes 38 direct the exit airflow 462 generally upward.

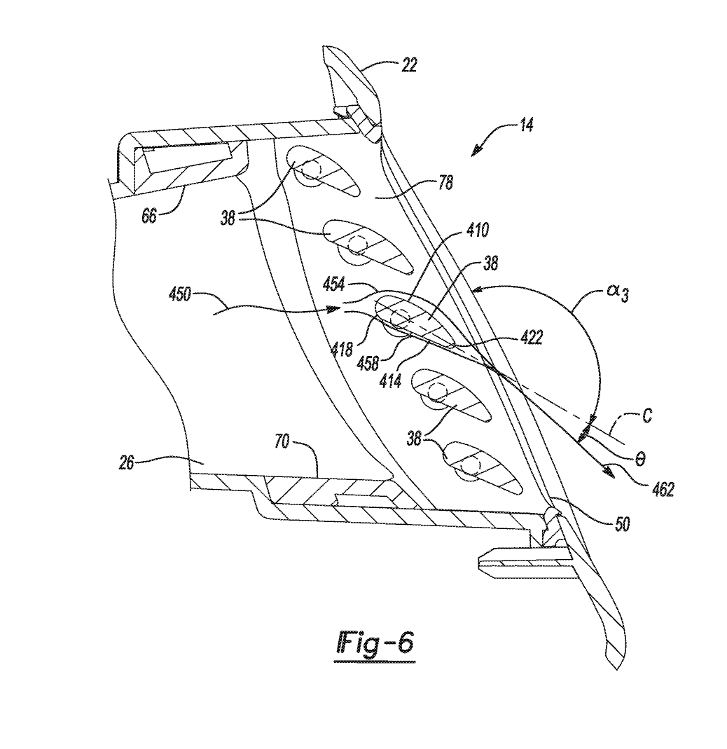

With additional reference to FIG. 6, the primary direction vanes 38 are rotated clockwise about their longitudinal axes such that the chord line (i.e., line C) is at an angle α₃ relative to the panel 22. In the example provided, the angle α₃ is greater than α₁ (FIG. 4) and is such that the primary direction vanes 38 direct the exit airflow 462 generally downward to a greater extent than when the primary direction vanes 38 are positioned as shown in FIG. 4.

In one alternative construction, not specifically shown, the primary direction vanes 38 are oriented differently, such that the low pressure side 410 is below the high pressure side 414 and the angle θ is not a downward angle relative to the ground, but is instead an upward angle.

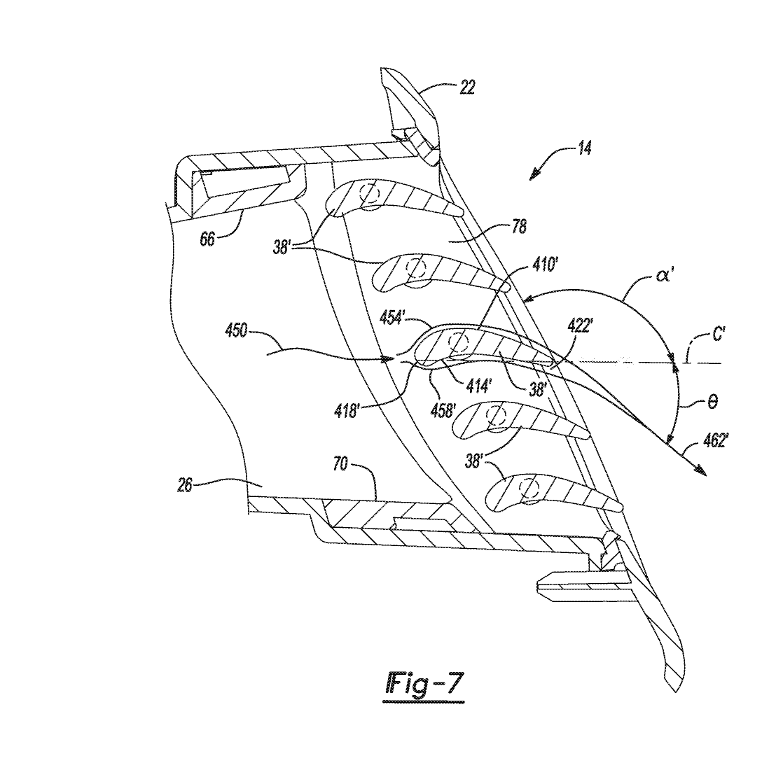

With additional reference to FIG. 7, an alternative construction of the primary direction vanes is illustrated and indicated by reference numeral 38′. The primary direction vanes 38′ are similar to the primary direction vanes 38 (FIGS. 1-6) except as otherwise illustrated or described herein. Accordingly, similar but primed reference numerals denote elements similar to those denoted by non-primed reference numerals described with reference to FIGS. 1-6. The primary direction vanes 38′ have a low pressure side 410′ and a high pressure side 414′ that join upstream to form a leading edge 418′ of the airfoil shape and join downstream to form a trailing edge 422′ of the airfoil shape. The leading edge 418′ and the trailing edge 422′ are rounded, but the primary direction vanes 38′ are generally thicker toward the leading edge 418′ and narrow toward the trailing edge 422′. In the example provided, the entire low pressure side 410′ is convex and the high pressure side 414′ is generally concave. In the example provided, the distance between the low pressure side 410′ and the high pressure side 414′, perpendicular to the chord of the airfoil shape (i.e., the thickness of the airfoil shape), is greatest at a point of greatest thickness between the leading edge 418′ and the trailing edge 422′. The lateral distance between the leading edge 418′ and the point of greatest thickness is less than the lateral distance between the trailing edge 422′ and the point of greatest thickness. The thickness of the airfoil shape continually decreases in either direction with increased distance from this point of greatest thickness until reaching leading edge 418′ or the trailing edge 422′.

A line parallel with a chord line of the airfoil shape is indicated by reference numeral C′. The chord line (i.e., line C′) is at an angle α′ relative to the panel 22. The leading edge 418′ is disposed within the duct 26 and the trailing edge 422′ is disposed generally at the outlet aperture 50 such that the trailing edge 422′ is visible from the passenger compartment (not shown).

Airflow from the inlet aperture 46 (FIG. 1) of the duct 26 to one of the primary direction vanes 38′ is indicated schematically by arrow 450′. It is understood that airflow through the duct 26 passes similarly over all of the primary direction vanes 38′. The leading edge 418′ of the primary direction vane 38′ causes the airflow 450′ to split in order to travel around the primary direction vane 38′. A portion 454′ of the airflow 450′ travels along the low pressure side 410′ of the primary direction vane 38′ and a portion 458′ of the airflow 450′ travels along the high pressure side 414′ of the primary direction vane 38′. The portion 454′ traveling along the low pressure side 410′ has a higher velocity and lower pressure than the portion 458′ traveling along the high pressure side 414′. As the portions 454′, 458′ leave the primary direction vane 38′ from the trailing edge 422′, the portions 454′, 458′ generally converge to form an exit airflow 462′ that exits the duct 26 at the outlet aperture 50. The exit airflow 462′ generally exits the duct 26 at an angle θ′ relative to the chord line (i.e., line C′). In the example shown in FIG. 7, when the chord line (i.e., line C′) is a horizontal axis (i.e., level to the ground), the angle θ′ is such that the exit airflow 462′ exits the duct 26 at a downward angle that is greater than angle θ (FIG. 4). In the example provided, there are no other vanes downstream of the primary direction vanes 38′, such that the air immediately exits the duct 26 after the primary direction vanes 38′.

Returning to FIGS. 1 and 2, the auxiliary air outlet 18 is generally similar to the main air outlet 14, except as otherwise illustrated or described herein. In the example provided, the auxiliary air outlet 18 includes an auxiliary duct 110 and a plurality of auxiliary vanes 114. The auxiliary duct 110 has an auxiliary inlet aperture 118 and an auxiliary outlet aperture 122. The auxiliary inlet aperture 118 is configured to be connected to other ducts (not shown) to receive air blown from the fan (not shown) of the HVAC system 10. The auxiliary outlet aperture 122 is open at the panel 22 to permit air to flow from the auxiliary inlet aperture 118, through the auxiliary duct 110, out the auxiliary outlet aperture 122 and into the passenger compartment (not shown) of the vehicle (not shown). In one optional configuration of the auxiliary air outlet 18, a baffle door (not shown but similar to baffle door 54) is disposed in either the auxiliary duct 110, or another duct leading to the auxiliary duct 110, to control airflow through the auxiliary duct 110.

Unlike the main air outlet 14, the auxiliary air outlet 18 does not include additional vanes besides the auxiliary vanes 114 and the auxiliary vanes 114 are fixedly disposed in the auxiliary duct 110 at the auxiliary outlet aperture 122. The auxiliary vanes 114 extend longitudinally across the auxiliary outlet aperture 122 to be generally parallel to each other. The auxiliary vanes 114 have a subsonic, asymmetrical airfoil cross-sectional shape that is similar to the primary direction vanes 38 or 38′. Thus, air flowing through the auxiliary duct 110 is directed by the auxiliary vanes 114 to exit the auxiliary outlet aperture 122 at an angle relative to a chord line of the auxiliary vanes 114 in a manner similar to that of the exit airflow 462 or 462′ exiting the outlet aperture 50.

As described above, the vanes 38, 38′, and 114 are configured to provide airflow from a corresponding outlet aperture 50, or 122, at an angle relative to the outlet aperture 50, or 122 and relative to the cord of the vanes 38, 38′, and 114. The airfoil shape of the vanes 38, 38′, and 114 also allows the airflow to have a more laminar flow around the vanes 38, 38′, and 114, and to exit the corresponding outlet aperture 50, or 122, with less turbulence and less pressure drop for a given downward airflow angle than typical vanes (not shown). This permits the panel 22 to be positioned at a greater angle relative to horizontal, than outlets with typical vane profiles. The airfoil shape of the vanes 38, 38′, and 114 also improves aesthetics of the corresponding air outlet 14, or 18 by having a more curved appearance from the passenger compartment (not shown) of the vehicle (not shown).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An air outlet of an heating, ventilation, and air conditioning system of a vehicle, the air outlet comprising:
a duct having an inlet aperture for receiving an airflow from the heating, ventilation, and air conditioning system, and an outlet aperture that is open to a passenger compartment of the vehicle; and
a plurality of primary vanes coupled to the duct at the outlet aperture, each primary vane having an asymmetrical airfoil shape including a leading edge and a trailing edge, the leading edge being disposed within the duct and upstream of the trailing edge.

2. The air outlet of claim 1, wherein the outlet aperture is formed at an angle relative to a horizontal axis, and when a cord line of one of the primary vanes is parallel to the horizontal axis, the one of the primary vanes is configured to direct the airflow at a downward angle relative to the horizontal axis.

3. The air outlet of claim 1, wherein the primary vanes have a thickness that narrows toward the trailing edge and a lateral distance between the leading edge and a point of greatest thickness of each primary vane is less than a lateral distance between the trailing edge and the point of greatest thickness of that primary vane.

4. The air outlet of claim 1, wherein a low pressure side of the airfoil shape is convex and a high pressure side of the airfoil shape is convex, the high pressure side being less convex than the low pressure side.

5. The air outlet of claim 1, wherein a low pressure side of the airfoil shape is convex and a high pressure side of the airfoil shape is flat or concave.

6. The air outlet of claim 1, wherein the air outlet is devoid of other vanes downstream of the primary vanes.

7. The air outlet of claim 1, wherein each of the primary vanes is rotatably coupled to the duct to rotate about a respective longitudinal axis of the primary vane.

8. The air outlet of claim 7, wherein the primary vanes are coupled together such that rotation of one of the primary vanes causes all of the primary vanes to rotate.

9. The air outlet of claim 8, further comprising a plurality of secondary vanes, the secondary vanes being rotatably coupled to the duct to rotate along a corresponding longitudinal axis of each secondary vane, the secondary vanes being disposed transverse to and upstream of the primary vanes.

10. The air outlet of claim 9, wherein the longitudinal axis of each of the primary vanes is horizontal and the longitudinal axis of each of the secondary vanes is vertical.

11. The air outlet of claim 9, wherein the secondary vanes are coupled together such that rotation of one of the secondary vanes causes all of the secondary vanes to rotate.

12. The air outlet of claim 11, further comprising an input member coupled to the one of the primary vanes to slide along the longitudinal axis of the one of the primary vanes, the input member being coupled to the one of the primary vanes for common rotation, the input member being coupled to the one of the secondary vanes and configured to rotate the one of the secondary vanes when the input member slides relative to the one of the primary vanes.

13. The air outlet of claim 1, wherein each of the primary vanes is fixedly coupled to the duct.

14. The air outlet of claim 1, wherein each of the primary vanes is configured to direct the airflow in a direction that is transverse to a cord line of each primary vane.
